(19) United States
(12) Patent Application Publication
(10) Pub. No.: US 2002/0002643 A1
(43) Pub. Date: Jan. 3, 2002

(54) Portable information terminal, recording medium, and program

(76) Inventors: Tetsuji Yamamoto, Tokyo (JP); Koji Tada, Tokyo (JP); Toshimitsu Ohdaira, Tokyo (JP); Teruhiko Kakinuma, Tokyo (JP)

Correspondence Address: LERNER,DAVID, LITTENBERG, KRUMHOLZ & MENTLIK, LLP, 600 SOUTH AVENUE WEST, WESTFIELD, NJ, 07090-1497, US

(21) Appl. No.: 09/737,349

(22) Filed: Dec. 15, 2000

(30) Foreign Application Priority Data
Dec. 15, 1999 (JP) 11-356476

(51) Int. Cl. G06F 13/12; G06F 13/38

(52) U.S. Cl. 710/73; 710/65

(57) ABSTRACT

A study mode processing means incorporated in a portable information terminal has a input processing means for instructing an LED to emit light in response to the inputting of a code by the user, a light-emitting signal generating means for generating and outputting a light-emitting signal to the LED according to a turn-on or turn-off instruction from the input processing means, a character converting means for converting code information based on a code entered by the user into character information, a character displaying means for displaying a reference character to be studied, a determining means for determining whether character information based on code information entered by the user matches the reference character or not, and a determined result displaying means for displaying a determined result from the determining means on the display unit.

### BACKGROUND OF THE INVENTION

1. Field of the Invention

The present invention relates to a portable information terminal which the user can hold and play by hand and which can also be used as an auxiliary memory device for use with information apparatus, a recording medium storing programs and data to be downloaded into such a portable information terminal, and a program itself.

2. Description of the Related Art

Slave units such as memory cards for insertion into master units such as information apparatus, e.g., entertainment apparatus including video game machines, comprise an interface for connection to the master unit and a nonvolatile memory device for storing data.

FIG. 32 of the accompanying drawings shows an arrangement of major components of a conventional memory-card 1000. As shown in FIG. 32, the memory card 1000 comprises a control means 1002 for controlling operation of the memory card 1000, a connector 1004 for connection to a terminal in a slot in the information apparatus, and a nonvolatile memory 1006 for storing data. The connector 1004 and the nonvolatile memory 1006 are connected to the control means 1002.

The control means 1002 comprises a microcomputer, for example. The nonvolatile memory 1006 comprises a flash memory, an EEPROM, or the like. The memory card 1000 also includes an interface for connection to the information apparatus or the like, and the interface may comprise a microcomputer as a control means for interpreting a protocol.

FIG. 33 of the accompanying drawings shows control items in the control means 1002 of the conventional memory card 1000.

As shown in FIG. 33, the conventional memory card 1000 only has an apparatus connection interface for connection to the information apparatus and a memory interface for storing data into and reading data from the nonvolatile memory 1006.

Conventional entertainment apparatus which allow users to enjoy home TV games have a function to store programs and data into auxiliary memory devices. The above memory card is also used as an auxiliary memory device for such entertainment apparatus.

FIG. 34 of the accompanying drawings shows a conventional entertainment apparatus 1010 which uses a memory card as an auxiliary memory device. As shown in FIG. 34, the entertainment apparatus 1010 has a housing 1012 essentially in the shape of a flat rectangular parallelepiped, which has a disk loading unit 1014 disposed centrally therein for loading an optical disk as a recording medium storing an application program, a reset switch 1016 for resetting a program which is being executed at present, a power supply switch 1018, a disk control switch 1020 for controlling the loading of the optical disk, and two slots 1022A, 1022B, for example.

The memory card 1000 for use as an auxiliary memory device is inserted into either one of the slots 1022A, 1022B. A result produced when a program is executed on the entertainment apparatus 1010 is transmitted from the control means (CPU) 1024 of the entertainment apparatus 1010, and written in the nonvolatile memory 1006. A plurality of manual controllers, not shown, may be connected respectively to the slots 1022A, 1022B to allow a plurality of users to play a competition game simultaneously

It has been proposed to give a function to execute a program such as a game program to the slave unit connected to the entertainment apparatus serving as the master unit via one of the memory card slots. The slave unit with such a function can also be used as a portable information terminal, and will find a wide range of applications by facilitating communications between itself and other devices, resulting in new demands for such portable information terminals.

### SUMMARY OF THE INVENTION

It is therefore an object of the present invention to provide a portable information terminal that can be used as a portable game machine and is capable of generating character information according to the Morse code, for example, and performing communications based on such character information, and a recording medium storing programs and data to be downloaded into such a portable information terminal.

A portable information terminal according to the present invention comprises a housing having input means for entering an input, control means for executing a program, and display means for displaying a generated image, and character converting and displaying means operable on the control means for converting an unequal-length code inputted via the input means into character information and displaying the character information on the display means.

According to the present invention, there is also provided a recording medium storing a program and data for use in a portable information terminal having input means for entering an input, control means for executing a program, and display means for displaying a generated image, the program being operable on the control means and comprising the steps of converting an unequal-length code inputted via the input means into character information, and displaying the character information on the display means.

According to the present invention, there is further provided a program readable and executable by a computer, for use in having input means for entering an input, control means for executing a program, and display means for displaying a generated image, the program being operable on the control means and comprising the steps of converting an unequal-length code inputted via the input means into character Information, and displaying the character information on the display means.

With the above arrangement, an unequal-length code, i.e., a code wherein a combination of dots and dashes differs from character to character, e g., a Morse code, entered via the input means is converted into character information, which is displayed on the display means. The portable information terminal allows the user to generate characters with Morse codes.

The housing may have light-emitting means for emitting light in-response to a light-emitting signal, and the portable able information terminal or the program may further comprise light-emitting signal generating means operable on the control means for, or the steps of, generating a light-emitting signal in synchronism with the inputting of the unequal-length code and outputting the generated light-emitting signal to the light-emitting means.

In response to the inputting of the unequal-length code, the light-emitting means emits light. The user can recognize the relationship between a Morse code and a character based on a visual sensation such as of light emission as well as the inputting of the Morse code. The emission of light is effective to assist the user in memorizing Morse codes, for example.

The portable information terminal or the program may further comprise code converting means operable on the control means for, or the step of, converting character information inputted via the input means into an unequal-length code.

Since the inputted character information is converted into a corresponding unequal-length code, the portable information terminal is suitable for use in communications with external devices using Morse codes.

The housing may have light-emitting means for emitting light in response to a light-emitting signal, and the portable information terminal or the program may further comprise light-emitting signal generating means operable on the control means for, or the step of, generating a light-emitting signal based on the converted unequal-length code and outputting the generated light-emitting signal to the light-emitting means.

Because the light-emitting means emits light depending on a converted Morse code corresponding to inputted character information, the portable information terminal makes it possible to perform optical communications using Morse codes.

The housing may have communication means for exchanging information with an external device, and the portable information terminal or the program may further comprise information transmitting means operable on the control means for, or the step of, transmitting the character information via the communication means to the external device, or information receiving means operable on the control means for, or the steps of, receiving the character information via the communication means from the external device, and displaying the received character information on the display means.

The portable information terminal is capable of performing sending and receiving character information through both optical communications using Morse codes and wireless communications in a radio frequency range (RF range) and an infrared range (IR range). The user finds it interesting to use the portable information terminal because it can simulate communications using Morse codes.

The above and other objects, features, and advantage of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of an entertainment system to which a portable information terminal according to the present invention is connected;

FIG. 2 is a plan view of the portable information terminal according to the present invention;

FIG. 3 is a perspective view of the portable information terminal according to the present invention;

FIG. 4 is a perspective view of the portable information terminal with a lid being open;

FIG. 5 Is a front elevational view of the portable information terminal with the lid open;

FIG. 6 is a block diagram of a circuit arrangement of an entertainment apparatus:

FIG. 7 is a block diagram of a circuit arrangement of the portable information terminal according to the present invention;

FIG. 8A is a plan view of the portable information terminal with a displayed image in a study mode;

FIG. 8B is a plan view of the portable information terminal with a list of characters displayed on a display unit thereof;

FIG. 9A is a plan view of the portable information terminal with an error image displayed when there is no character information corresponding to a sign inputted by the user;

FIG. 9B is a plan view of the portable information terminal with an error image displayed when character information corresponding to a sign inputted by the user and reference character information do not match each other;

FIG. 9C is a plan view of the portable information terminal with an Image displayed when character information corresponding to a sign inputted by the user and reference character information match each other;

FIG. 10 is a plan view of the portable information terminal with an image displayed in a practice mode;

FIG. 11 is a plan view of the portable information terminal with an image displayed in a self-teaching mode;

FIG. 12 is a plan view showing two portable information terminals which are sanding and receiving data in a conversation mode;

FIG. 13 is a functional block diagram of a terminal information processing means that operates on a CPU of the portable information terminal;

FIG. 14 is a functional block diagram of a study mode processing means;

FIG. 15 is a diagram showing details of an information table;

FIG. 16 is a flowchart of a processing sequence of an input processing means;

FIG. 17 is a functional block diagram of a character converting means;

FIGS. 18 and 19 show a flowchart of a processing sequence of the study mode processing means;

FIGS. 20 and 21 show a flowchart of a processing sequence of the character converting means;

FIG. 22 is a functional block diagram of a practice mode processing means;

FIG. 23 is a flowchart of a processing sequence of the practice mode processing means;

FIG. 24 is a functional block diagram of a self-teaching mode processing means;

FIG. 25 is a flowchart of a processing sequence of the self-teaching mode processing means;

FIG. 26 is a functional block diagram of a first conversation mode processing means;

FIG. 27 is a flowchart of a processing sequence of a transmitter of the first conversation mode processing means;

FIG. 28 is a flowchart of a processing sequence of an LED processing means;

FIG. 29 is a flowchart of a processing sequence of a receiver of the first conversation mode processing means;

FIG. 30 is a functional block diagram of a second conversation mode processing means;

FIG. 31 is a flowchart of a processing sequence of a transmitter of the second conversation mode processing means;

FIG. 32 is a block diagram of an arrangement of major components of an ordinary memory card;

FIG. 33 is a diagram showing control items in a control means of the ordinary memory card; and

FIG. 34 is a plan view of an entertainment apparatus which uses a memory card as an auxiliary memory device.

### DESCRIPTION OF THE PREFERRED EMBODIMENTS

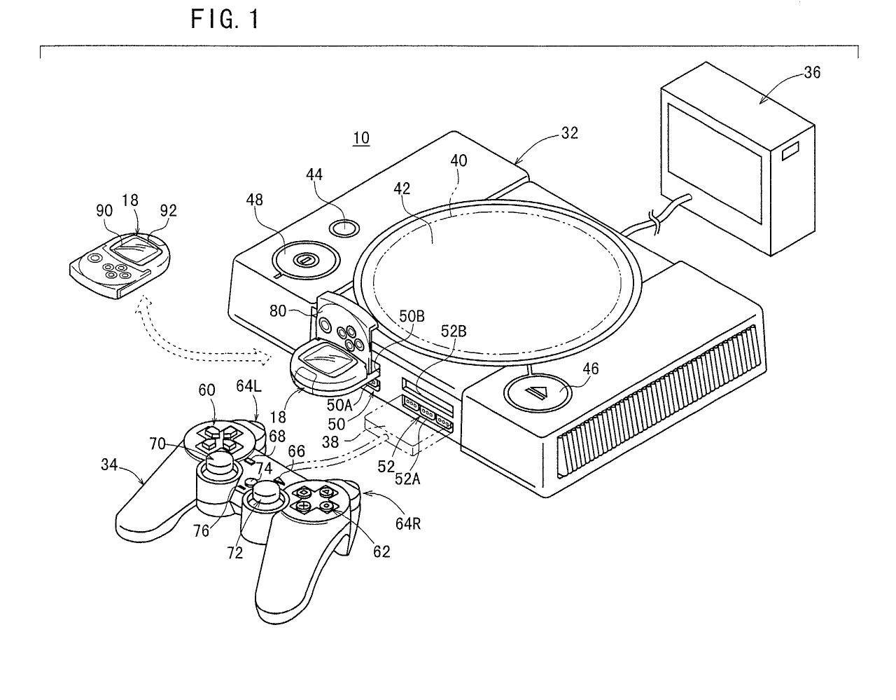

A portable information terminal according to the present invention that can be used as a portable game machine, and a recording medium and a program according to the present invention which are used respectively as a recording medium which stores a program and data executed by the portable information terminal and such a program will be described below with reference to FIGS. 1 through 31.

As shown in FIG. 1, an entertainment system 10 includes an entertainment apparatus 32 which serves as a master unit for a portable information terminal 18, the portable information terminal 18 detachably connected to the entertainment apparatus 32, a manual controller 34 detachably connected to the entertainment apparatus 32 by a connector 38, and a display monitor 36 such as a television receiver which is supplied with video and audio output signals from the entertainment apparatus 32.

The entertainment apparatus 32 can read a program recorded in a mass storage medium such as an optical disk 40 such as a CD-ROM, for example, and execute a game, for example, based on the program depending on commands supplied from the user, e.g., the game player. The execution of the game mainly represents controlling the progress of the game by controlling the display of images and the generation of sounds on the display monitor 36 in response to Input signals from the manual controller 34 via the connector 38.

The entertainment apparatus 32 is essentially in the shape of a flat rectangular parallelepiped, and has a disk loading unit 42 disposed centrally therein for loading an optical disk 40 storing an application program and data of a video game or the like, a reset switch 44 for resetting a program which is being executed at present, a disk control switch 46 for controlling the loading of the optical disk 40, a power supply switch 48, and two slots 50, 52, for example.

The entertainment apparatus 32 may be supplied with the application program via a communication link, rather than being supplied from the optical disk 40 as the recording medium

The slots 50, 52 have respective upper slot units SOB, 52B and respective lower slot units 50A, 52A. Manual controllers 34 can be connected respectively to the lower slot units 50A, 52A. Memory cards (not sown) capable of storing flags indicative of interim game data or portable information terminals 18 which also function as memory cards can be connected to respectively to the upper slot units 50B, 52B. The slots 50 (50A, 50B) and the slots 52 (52A, 52B) are of asymmetrical shapes to avoid erroneous insertion of manual controllers and memory cards or portable information terminals.

The manual controller 34 has first and second control pads 60, 62, an L button 64L, an R button 64R, a start button 66, and a selection button 68. The manual controller 34 also has first and second joysticks 70, 72 for making analog control actions, a mode selection switch 74 for selecting control modes of the joysticks 70, 72, and an indicator 76 for indicating a selected control mode

The portable information terminal 18 with a lid 80 being open is connected to the entertainment apparatus 32. A program and data are downloaded from the entertainment apparatus 32 into the portable information terminal 18 which is connected to the entertainment apparatus 32. In this sense, the entertainment apparatus 32 is considered to be a downloading apparatus.

When the portable information terminal 18 is disconnected from the entertainment apparatus 32, stated otherwise, when the portable information terminal 18 is a stand-alone system, the portable information terminal 18 can be operated on a build-in battery to execute a program downloaded from the entertainment apparatus 32.

Portable information terminals 18 can be used as inherent memory cards corresponding to a plurality of manual controllers 34 connected to the entertainment apparatus 32. For example, if two users (game players) take part in playing a game on the entertainment system 10, game results of the users are recorded respectively in the portable information terminals 18.

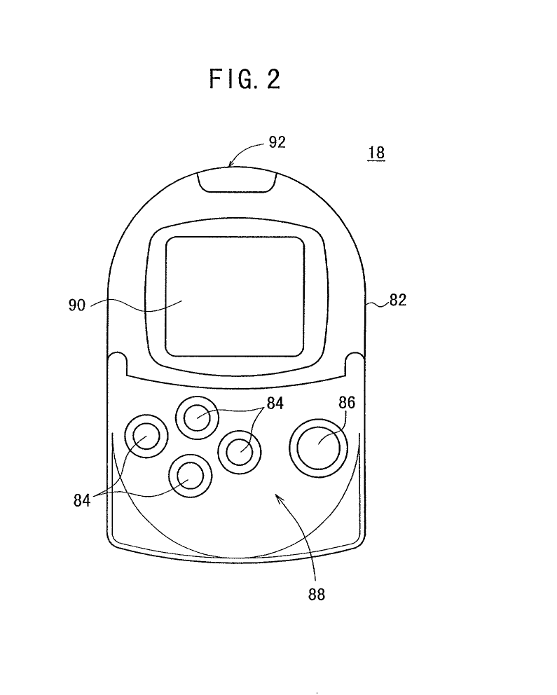

As shown in FIGS. 2 through 5, the portable information terminal 18 has a housing 82 which supports a manual control pad 88 having a plurality of direction buttons 84 and a decision button 86 for entering events and making various selections, a display unit 90 comprising a liquid crystal display (LCD) unit or the like, and a window 92 for wireless communication via infrared radiation or the like.

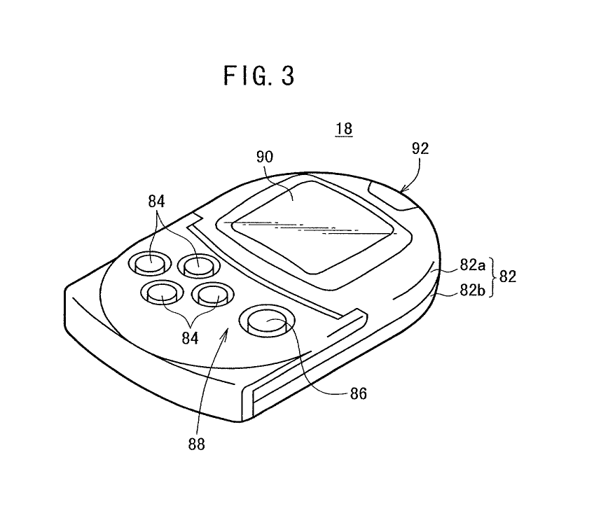

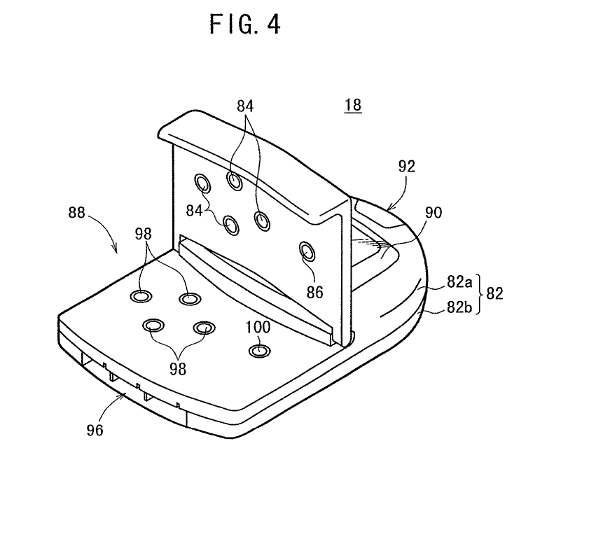

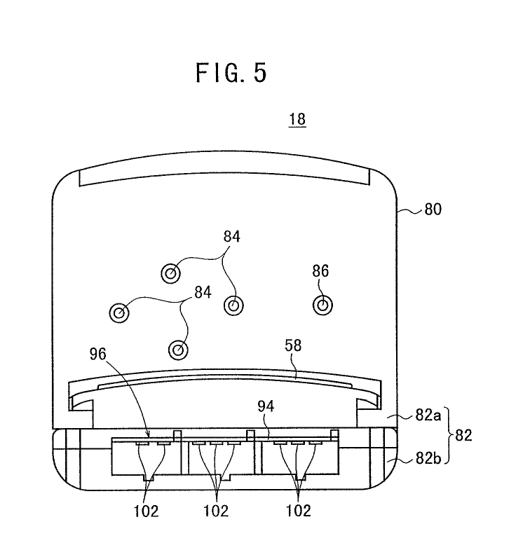

As shown In FIGS. 3 and 4, the housing 82 comprises an upper shell 82a and a lower shell 82b. The housing 82 houses a board 94 which supports a memory device, etc. thereon, as shown in FIG. 5. The housing 82 can be inserted into either one of the slots 50, 52 of the entertainment apparatus 32, and has a connector 96 disposed in an end thereof and having a elongate rectangular window.

The window 92 is disposed on an opposite end of the housing 82 which is of a substantially semicircular shape. The display unit 90 occupies a substantially half area of the upper shell 82a and is positioned near the window 92.

The manual control pad 88 occupies another substantially half area of the upper shell 82a and is positioned remotely from the window 92. As shown in FIG. 4, the manual control pad 88 comprises a substantially square lid 80 that is angularly movably supported on the housing 82 and supports thereon one or a plurality of the direction buttons 84 and the decision button 86, and switch pressers 98, 100 positioned in an area of the housing 82 which can be opened and closed by the lid 80.

The direction buttons 84 and the decision button 86 extend through the lid 80. The direction buttons 84 and the decision button 86 are supported on the lid 80 for movement into and out of the upper surface of the lid 80. The switch pressers 98, 100 have respective pressing elements supported on the housing 82 for movement into and out of the upper surface of the housing 82. When one of the pressing elements is pressed from above, it presses a corresponding pressure switch such as a diaphragm switch, for example, mounted on the board 94 in the housing 82.

With the lid 80 closed, the switch pressers 98, 100 are held in vertical alignment with the direction buttons 84 and the decision button 86, respectively. Therefore, while the lid 80 is being closed over the housing 82, when the direction buttons 84 and,the decision button 86 are pressed from above into the upper surface of the lid 80, the direction buttons 84 and the decision button 86 cause the pressing elements of the corresponding switch pressers 98, 100 to press corresponding pressure switches in the housing 82.

As shown in FIG. 5, power and signal terminals 102 are mounted on the board 94 and disposed in the window of the connector 96. The connector 96 has a shape and dimensions that are identical to those of ordinary memory cards for use with the entertainment apparatus 32.

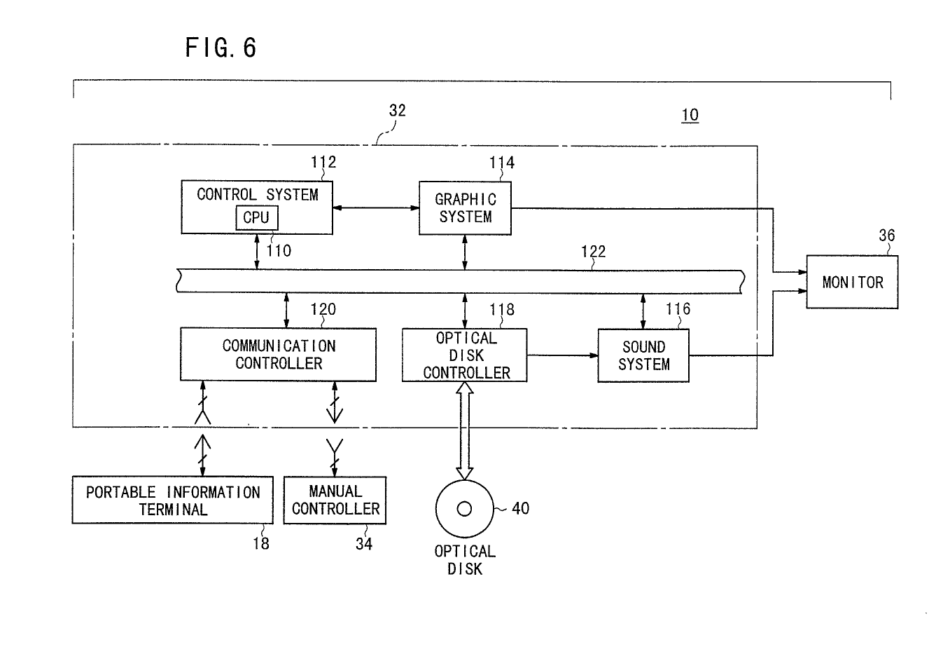

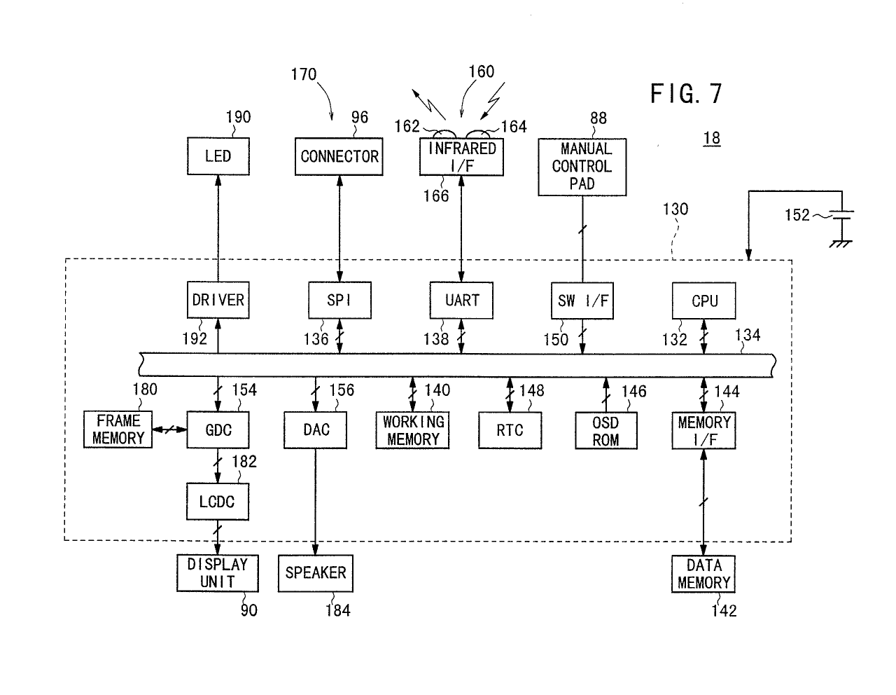

Circuit arrangements of the entertainment apparatus 32 and the portable information terminal 18 will be described below with reference to FIGS. 6 and 7.

As shown in FIG. 6, the entertainment apparatus 32 comprises a control system 112 including a central processing unit (CPU) 110 and peripheral devices thereof, a graphic system 114 including a frame buffer and a graphic processing unit (GPU) for rendering image data in the frame buffer, a sound system 116 including a sound processing unit (SPU) for generating music sounds and sound effects, an optical disk controller 118 for controlling the readout of the optical disk 40 in Which application programs and data are stored, a communication controller 120 for controlling the inputting of data into and outputting of data from the manual controller 34, the portable information terminal 18, or the memory card (not shown), and a system bus 122 to which the control system 112, the graphic system 114, the sound system 116, the optical disk controller 118, and the communication controller 120 are connected.

Video and audio signals generated by and outputted from the graphic system 114 and the sound system 116 are supplied to the display monitor 36 to display images on the display screen of the display monitor 36 and reproduce sounds from the speakers of the display monitor 36

As shown in FIG. 7, the portable information terminal 18 has a controller 130 comprising a microcomputer or the like. The controller 130 has a CPU 132 for controlling the entire system of the portable information terminal 18 via a system bus 134.

To the system bus 134, there are connected, in addition to the CPU 132, a serial-parallel interface (SPI) 136 for communication with the entertainment apparatus 32, and a UART (Universal Asynchronous Receiver Transmitter) 138 which is an interface for asynchronous data transfer.

To the system bus 134, there are also connected a working memory 140 comprising an SRAM for temporarily storing data and processed results required for processing by the CPU 132, and a data memory (data storage memory) 142 as an external storage means via a memory Interface 144.

To the system bus 134, there are also connected a ROM (OSDROM) 146 comprising a flash memory and having an OSD (On Screen Display) function, and a real-time clock (RTC) 148 having a calendar and clock function. The OSDROM 146 stores a control program such as kernel.

The manual control pad 88 is connected to the system bus 134 via a switch interface (SW I/F) 150 which also functions as an interrupt generating means.

The system bus 134 is supplied with electric energy from a battery 152. When the portable information terminal 18 is disconnected from, i.e., independent of, the entertainment apparatus 32, the portable information terminal 18 can execute application software stored in the data memory 142. The contents of the data memory 142 are backed up by its nonvolatile memory capability even when the power supply of the portable information terminal 18 is turned off.

To the system bus 134, there are also connected a GDC (Graphic Display Controller) 154 as an image processing means, and a DAC (Digital-to-Analog Converter) 156 for converting a digital signal supplied from the system bus 134 into an analog signal. A red light-emitting diode (LED) 190, for example, as a light-emitting means is connected to the system bus 134 via a driver 192.

The portable information terminal 18 has two communication routes, i.e., a first communication route 160 and a second communication route 170, for receiving data from and outputting data to external devices.

The first communication route 160 comprises an infrared interface 166 which is a module according to IrDA (Infrared Data Association) having an infrared emitter 162 and an infrared detector 164, and the UART 138. Infrared signals are received from and outputted to external devices via the Infrared interface 166, converted from parallel into serial signals or from serial into parallel signals by the UART 138, and supplied to and outputted from the system bus 134.

The second communication route 170 comprises the connector (physical connector) 96 for making a physical connection, and the serial-parallel interface (SPI) 136. As described above, as shown in FIG. 1, the connector 96 is mounted In either one of terminal insertion units (upper slot units 50B, 52B) of the slots 50, 52 of the entertainment apparatus 32, supplies serial data of information from the entertainment apparatus 32, e.g., information read from the optical disk 40 (including application software of a game) to the SPI 136, which converts the serial data into parallel data and supplies the parallel data to the system bus 134.

An image is displayed on the display screen of the display unit 90 of the portable information terminal 18 as follows: The GDC 154 as the image processing means exchanges data with a frame memory 180 connected thereto, and controls an LCDC (Liquid Crystal Display Controller) 182, which is a controller for the liquid crystal display unit, to display an image on the display screen of the display unit 90.

Sound (including music sound) is outputted from a speaker 184 as a sound outputting means as follows: The DAC 156 for converting a digital signal into an analog signal receives digital sound data from the system bus 134, converts the digital sound data into analog sound data, and supplies the analog sound data to the speaker 184, which radiates corresponding sound.

Characteristic functions of the portable information terminal 18 according to the present invention will be described below.

The first function is to convert an unequal-length code entered via the manual control pad 88 into character information and display the character information on the display unit 90. The second function is to generate and output a light-emitting signal to the LED 190 in synchronism with the inputting of the unequal-length code to cause the LED 190 to emit light in response to the inputting of the unequal-length code.

The unequal-length code may comprise a Japanese Morse code or a European Morse code which is composed of a combination of dots (•) and dashes (-).

If the length (continuation time) of a dot is represented by one unit, then the length of a dash is represented by a length (continuation time) that is three times the length of the dot, i.e., three units. Two units or less are regarded as representing a dot, and three units or more are regarded as representing a dash. The interval between two codes, i.e., a separating no-input period or blank length, is represented by three units, and the interval between two words is represented by seven units.

The actual time of one unit is not determined as “00.1 second”, for example, i.e., there are no public rules defining the time of one unit. Therefore, the actual time of one unit may be set to a suitable value when a program is generated for the portable information terminal 18.

The third function is to convert character information entered via the manual control pad 88 into an unequal-length code. The fourth function Is to generate and output a light-emitting signal to the LED 190 based on the converted unequal-length code to cause the LED 190 to emit light depending on the converted unequal-length code which corresponds to the inputted character information.

The fifth function is to transmit the character information via the infrared emitter 162 to an external device, and receive character information detected from an external device via the infrared detector 164 and display the received character information on the display unit 90.

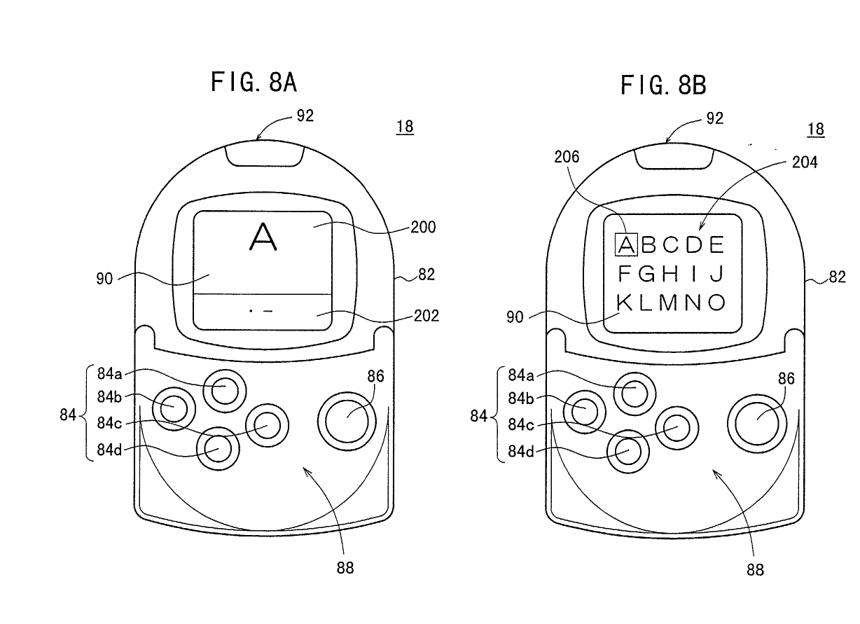

A video game (terminal game) played on the portable information terminal 18 with the above functions will be described below with reference to FIGS. 8A through 12.

The terminal game has a “study mode”, a “practice mode”, a “self-teaching mode”, and a “conversation mode”.

The study mode is a mode for browsing or studying the European Morse code and the Japanese Morse code, and confirming and testing characters and the Morse codes. In the study mode, as shown in FIG. 8A, the display unit 90 has its displayed view divided into a character display area 200 and a code display area 202.

For confirming characters and the Morse codes, when a desirers character is selected from a character list 204 displayed on the display unit 18 as shown in FIG. 8B, the selected character is displayed in the character display area 200 and a Morse code, i.e., a combination of dots and dashes, is displayed in the code display area 202, as shown in FIG. 8A

To select a character from the character list 204, as shown in FIG. 8B, the user moves a cursor 206 by pressing the direction buttons 84, I.e., an up button 84a, a left button 84b, a right button 84c, and a down button 84d, and presses the decision button 86 when the cursor 206 is positioned on the desired character. The desired character is now selected as shown in FIG. 8A. When the user continuously presses the up button 84a or the down button 84d while the character list 204 is being displayed, the displayed view scrolls upwardly or downwardly to allow the user to see the character list 204 in its entirety.

For confirming characters and the Morse codes from the displayed image shown in FIG. 8A, the user presses the left button 84b or the right button 84c to display the character list 204 again, and then operates the manual control pad 88 in the same manner as described above.

For testing characters and the Morse codes, the user presses the decision button 86 from the above confirming state to start a testing process. In the testing process the Morse code displayed in the code display area 202 is erased, and the manual control pad 88 waits for a Morse code to be entered by the user.

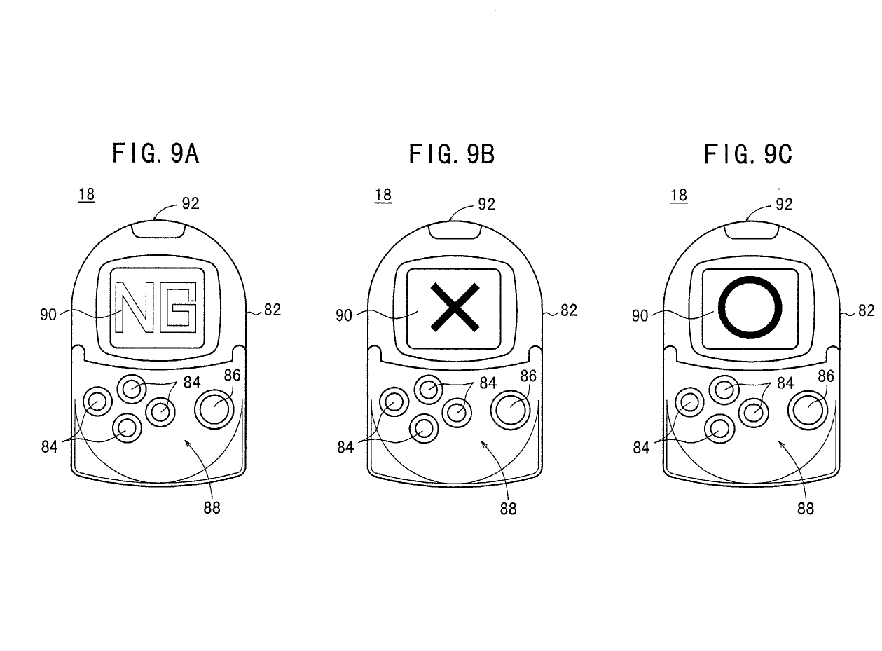

When the user presses the decision button 86 to enter a code in the form of a combination of dots and dashes, the entered code is displayed in the code display area 202. If there is no character corresponding to the entered code, then the display unit 90 displays “NG” in its entire displayed view, as shown in FIG. 9A.

If there Is a character corresponding to the entered code, but it does not match the selected character, then the display unit 90 displays “x” in its entire displayed view, as shown in FIG. 9B. If there is a character corresponding to the entered code, but It matches the selected character, then the display unit 90 displays “◯” in its entire displayed view, as shown in FIG. 9C.

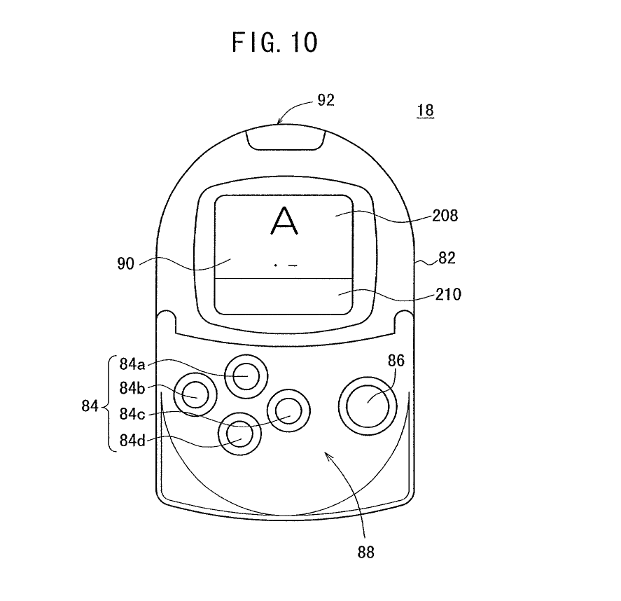

In the practice mode, as shown in FIG. 10, the display unit 90 has its displayed view divided into a reference display area 208 and an input display area 210. The reference display area 208 displays a computer-selected character and a Morse code corresponding to the computer-selected character, and the user enters the same Morse code as the Morse code displayed In the reference display area 208 within a certain limit time.

If the user correctly enters the Morse code within the limit time, then the display unit 90 displays “◯” in its entire displayed view, as shown in FIG. 9C. If the limit time has expired or the user enters a wrong Morse code, then the display unit 90 displays “x” In Its entire displayed view, as shown in FIG. 9B.

In the practice mode, ten consecutive questions may be presented, and the limit time may be 10 seconds, for example. A score of 100 points per question is given at the start of the practice mode, and will be reduced each time the user fails to answer the question. For example, the score is reduced one point each time a 6 sync. period has elapsed before the user answers the question, and the total points for the questions will be final points.

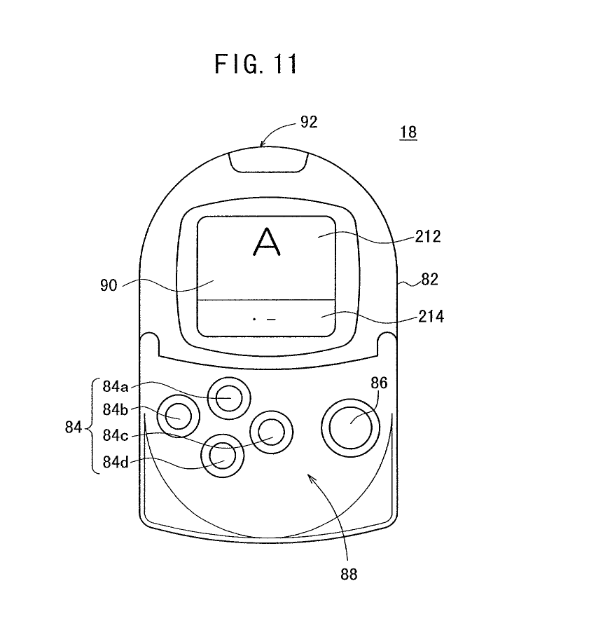

In the self-teaching mode, as shown in FIG. 11, the display unit 90 has its displayed view divided into a character display area 212 and an input display area 214. When the user enters a combination of dots and dashes, the input display area 214 displays the entered combination of dots and dashes. If there is a Morse code matching the entered combination of dots and dashes, then a character corresponding to the Morse code is displayed in the character display area 212. If there is no Morse code matching the entered combination of dots and dashes, then the display unit 90 displays “NG” in its entire displayed view, as shown in FIG. 9A.

In the study mode, the practice mode, and the self-teaching mode, when the user enters a Morse code using the decision button 86, the red LED 190, for example, is energized in response to the pressing of the decision button 86.

The conversation mode is a mode for sending and receiving information about words and phrases composed of a plurality of characters via the infrared emitter 162 and the infrared detector 164.

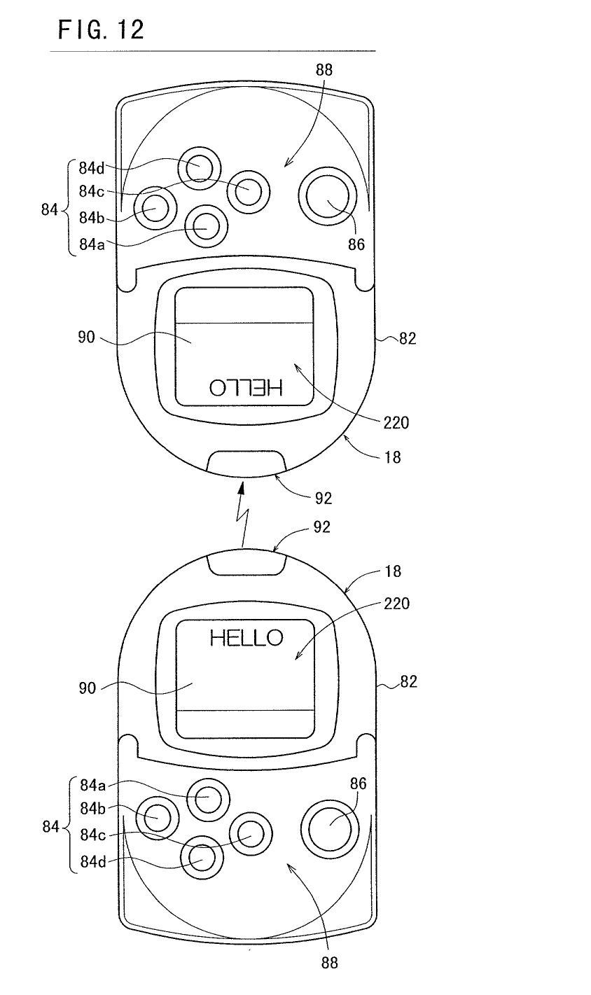

Specifically, as shown in FIG. 12, the user of the portable information terminal 18 that is used as a sending terminal enters a word 220 into the portable information terminal 18, and operates the portable information terminal 18 to send the entered word 220. Information about the entered word 220 is now sent to an external device via the infrared emitter 162.

A plurality of portable information terminals 18 are placed such that their windows 92, each housing the infrared emitter 162, the infrared detector 164, and the LED 190, face each other. The information about the entered word 220 which is sent from one of the portable information terminals 18 via the infrared emitter 162 is received by the other portable information terminal 18 via the infrared detector 164. In this manner, the users of the portable information terminals 18 can talk to or communicate with each other using the portable information terminals 18.

At this time, the display units 90 of the sending and receiving portable information terminals 18 display the word 220 that is sent and received.

The LED 190 may be arranged to emit light in synchronism with Morse codes corresponding to the characters of the word 220. With the LED 190 thus emitting light, the portable information terminals 18 look like having a conversation with each other using Morse codes.

If the user is skilled enough to be able to read Morse codes by looking at the emission of light from the LED 190 in the study mode, the practice mode, and the self-teaching mode, then the user of the portable information terminal 18 can have a conversation using Morse codes based on emitted light, without having to see the displayed word 220. Therefore, the user finds a lot of fun using portable information terminal 18 to talk to the user of another portable information terminal 18.

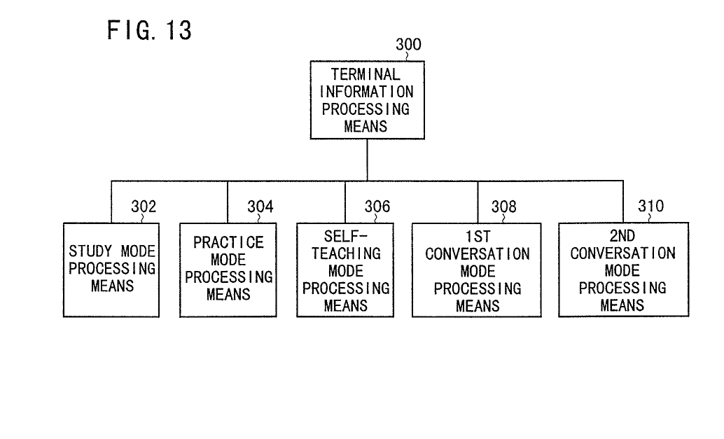

One example of software for performing the above characteristic functions will be described below with reference to FIGS. 13 through 31. As shown in FIG. 13, the software comprises a terminal information processing means 300. The software which will be described below is by way of illustrative purpose only. Various other types of software may be employed insofar as they can perform the above characteristic functions.

The terminal information processing means 300 can be supplied to the portable information terminal 18 via the entertainment system 10 from a randomly accessible recording medium such as a CD-ROM, the memory card 14, or a network. It is assumed in the present embodiment that the terminal information processing means 300 Is read from the optical disk 40 such as a CD-ROM into the portable Information terminal 18 via the entertainment apparatus 32.

The terminal information processing means 300 is downloaded in advance from the optical disk 40 played back by the entertainment apparatus 32 into the data memory 142 of the portable information terminal 18 via the entertainment apparatus 32, and executed by the CPU 132 of the portable information terminal 18.

As shown in FIG. 13, the terminal information processing means 300 comprises a study mode processing means 302, a practice mode processing means 304, a self-teaching mode processing means 306, a first conversation mode processing means 308, and a second conversation mode processing means 310 for the various modes described above.

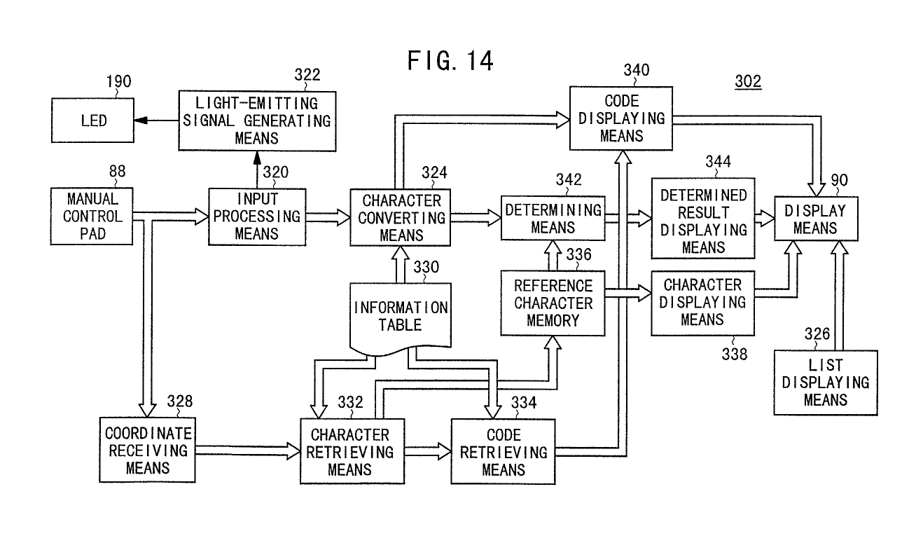

As shown in FIG. 14, the study mode processing means 302 comprises an input processing means 320 for instructing the LED 190 to emit light in response to the inputting of a code by the user, a light-emitting signal generating means 322 for generating and outputting a light-emitting signal to the LED 190 according to a turn-on or turn-off instruction from the input processing means 320, and a character converting means 324 for converting code information based on a code entered by the user into character information.

The input processing means 320 outputs a turn-on or turn-off signal depending on how the decision button 86 of the manual control pad 88 is operated, and instructs the LED 190 to emit light or turn off light depending on how the decision button 86 is operated. The character converting means 324 samples a turn-on or turn-off signal from the input processing means 320, converts the signal into code information comprising a combination of dots and dashes, and converts code information into character information.

The Study mode processing means 302 also comprises a list displaying means 326 for displaying a character list 204 (see FIG. 8B) on the display unit 90, a coordinate receiving means 328 for receiving positional information (coordinates) of the cursor 206 at the time the decision button 86 is operated while the character list 204 is being displayed, a character retrieving means 332 for retrieving character information from an information table 330 based on the received coordinates, and a code retrieving means 334 for retrieving code information corresponding to the retrieved character information from the information table 330. The character information retrieved by the character retrieving means 332 is stored in a reference character memory 336.

The study mode processing means 302 also comprises a character displaying means 338 for displaying the character information stored in the reference character memory 336 in the character display area 200 of the display unit 90, a code displaying means 340 for displaying the retrieved code information as a combination of dots and dashes in the code display area 202 of the display unit 90, a determining means 342 for determining whether the character information from the character converting means 324 matches the character information stores in the reference character memory 336 or not, and a determined result displaying means 344 for displaying a determined result from the determining means 342 on the display unit 90. The determining means 342 also determines whether error information is outputted from the character converting means 324 or not.

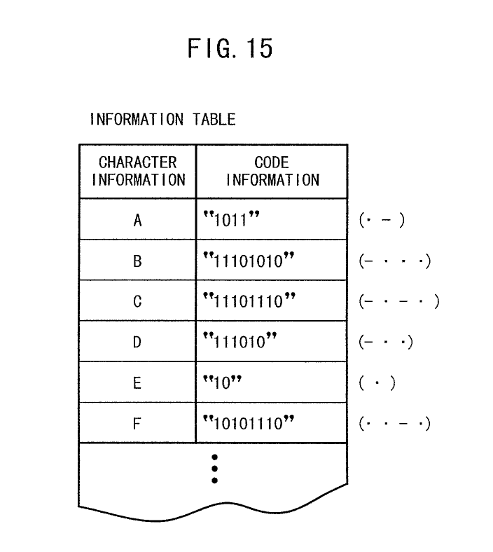

As shown in FIG. 15, the Information table 330 stores a plurality of records each containing character information and code information. The character information represents a Japanese character or a European character in the form of a JIS code. The code information represents a Morse code corresponding to the character information and comprising a combination of logic data “10” and “11”.

The logic data “10” represents a dot (•), and the logic data “11” represents a dash (−). For example, since the Morse code corresponding to the character “A” is “•−”, the code information “1011” is stored in association with the character “A”.

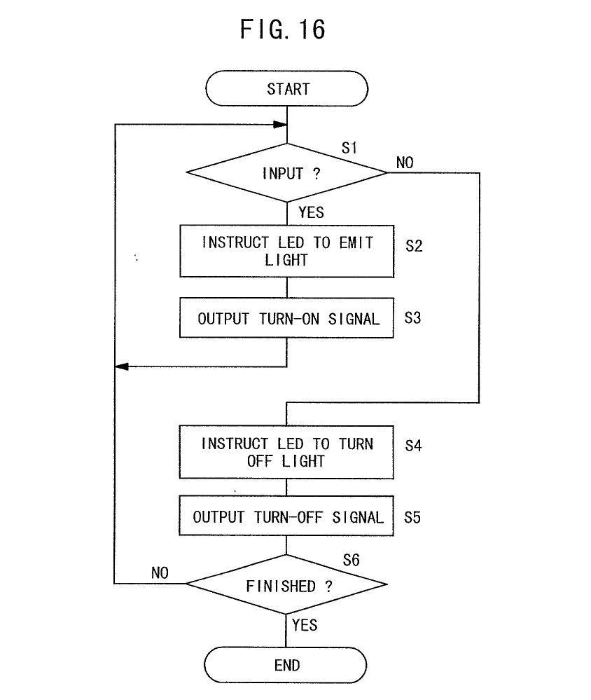

A processing sequence of the input processing means 320 will be described below with reference to FIG. 16. In step S1 shown in FIG. 16, the input processing means 320 determines whether there is an input from the decision button 86 or not. If there is an input from the decision button 86, then control goes to step S2 in which the input processing means 320 gives a turn-on instruction to the light-emitting signal generating means 322. The input processing means 320 then outputs a turn-on signal in step S3.

If there is no input from the decision button 86 in step S1, then control jumps to step S4 in which the input processing means 320 gives a turn-off instruction to the light-emitting signal generating means 322. The input processing means 320 then outputs a turn-off signal in step S5.

In step S6, the input processing means 320 determines whether there is a program end request for the input processing means 320 or not. If there is no program end request, then control goes back to step S1 to repeat the processing from step S1.

While the decision button 86 is being operated in the processing in steps S1-S6, the processing in steps S2, S3 is repeated to output a turn-on instruction and a turn-on signal successively. While the decision button 86 is not being operated in the processing in steps S1-S6, the processing in steps S4, S5 is repeated to output a turn-off instruction and a turn-off signal successively.

If there is a program end request in step S6, then the processing sequence of the input processing means 320 is put to an end.

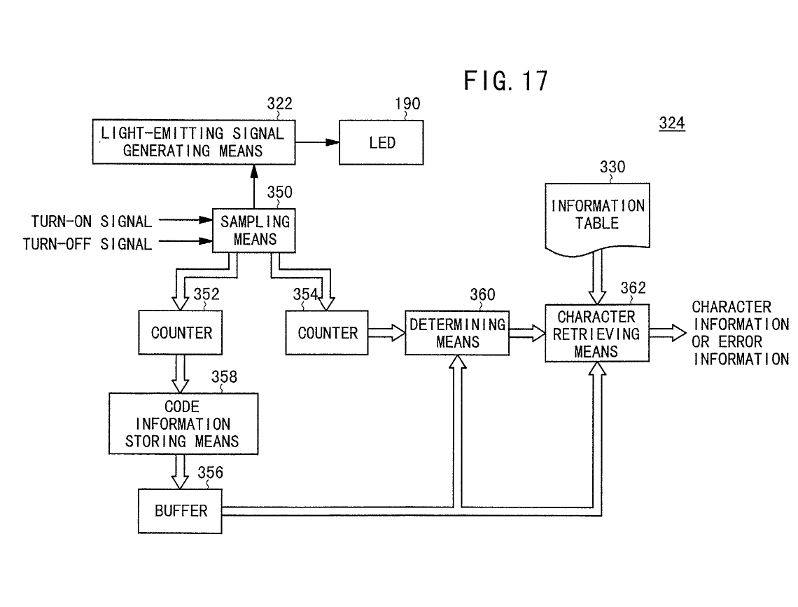

As shown in FIG. 17, the character converting means 324 comprises a sampling means 350 for sampling the outputting period of a turn-on signal or a turn-off signal based on one unit of Morse code, and counting units of a signal length in which the decision button 86 is operated and units of blank length in which the decision button 86 is not operated. The count of the units of the signal length Is stored in a first counter 352, and the count of the units of the blank length is stored in a second counter 354.

The character converting means 324 also comprises a code information storing means 358 for checking if the signal from the input processing means 320 represents dot information or dash information based on the count of the units of the signal length which is stored In the first counter 352, and storing the checked result into a buffer 356 in successive addresses, a determining means 360 for determining whether there is data in the buffer 356 and whether a character is to be converted or not based on the count of the units of the blank length which is stored in the second counter 354, and a character retrieving means 362 for retrieving character information corresponding to the code information stored in the buffer 356 from the information table 330.

If the code information storing means 358 finds dot information based on the count of the units of the signal length, then the code Information storing means 358 stores the logic data “10” into the buffer 356. If the code information storing means 358 finds dash information based on the count of the units of the signal length, then the code Information storing means 358 stores the logic data “11” into the buffer 356.

The character retrieving moans 362 outputs error information rather than character information if no character information corresponding to the code information stored in the buffer 356 is present in the information table 330.

A processing sequence of the study mode processing means 302 will be described below with reference to FIGS. 13, 18 through 21.

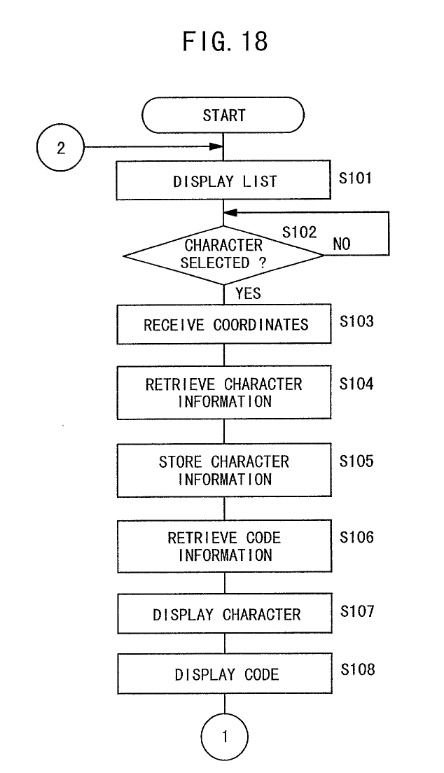

In step S101 shown in FIG. 18, the list displaying means 326 displays the character list 204 on the display unit 90, as shown in FIG. 8B.

In step S102, the study mode processing means 302 determines whether a character is selected or not based on whether there is an input from the decision button 86 or not. If there is an input from the decision button 86, then control goes to step S103 in which the coordinate receiving means 328 receives positional information (coordinates) of the cursor 206 at the time the decision button 86 is operated.

In step S104, the character retrieving means 332 retrieves character information from the information table 330 based on the received coordinates. Thereafter, in step S105, the character retrieving means 332 stores the retrieved character information into the reference character memory 336. In step S106, the code retrieving means 334 retrieves code information corresponding to the retrieved character information from the information table 330.

In step S107, the character displaying means 338 displays the character information stored in the reference character memory 336 in the character display area 200 of the display unit 90, as shown in FIG. 8A. In step S108, the code displaying means 340 displays the retrieved code information as a combination of dots and dashes in the code display area 202 of the display unit 90.

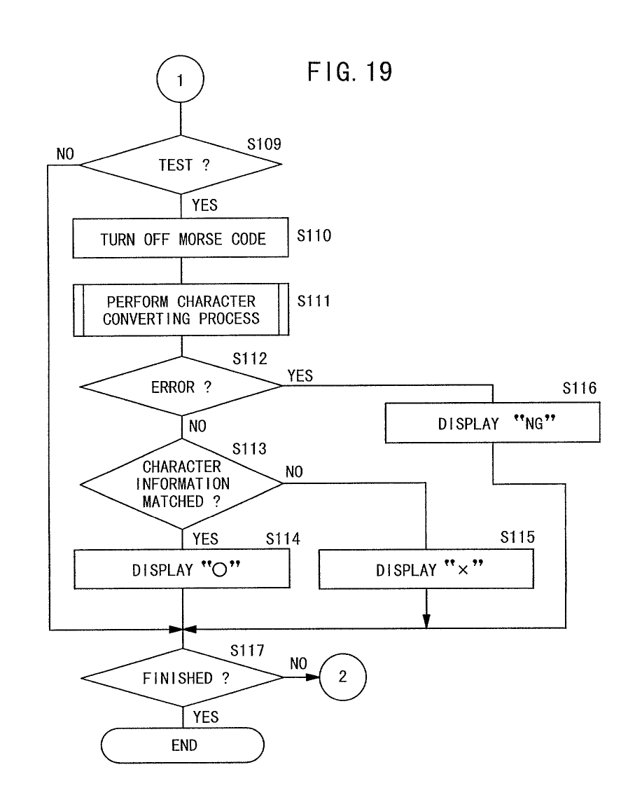

In step S109 shown in FIG. 19, the study mode processing means 302 determines whether there is a test request from the user or not. If there is a test request from the user, control then goes to step S110 in which the study mode processing means 302 erases the Morse code currently displayed in the code display area 202 of the display unit 90 Then, the character converting means 324 performs its own processing sequence in step S111.

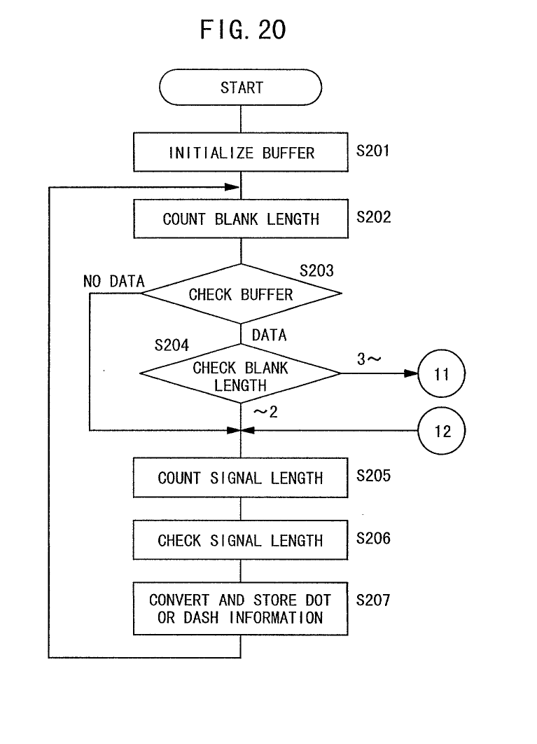

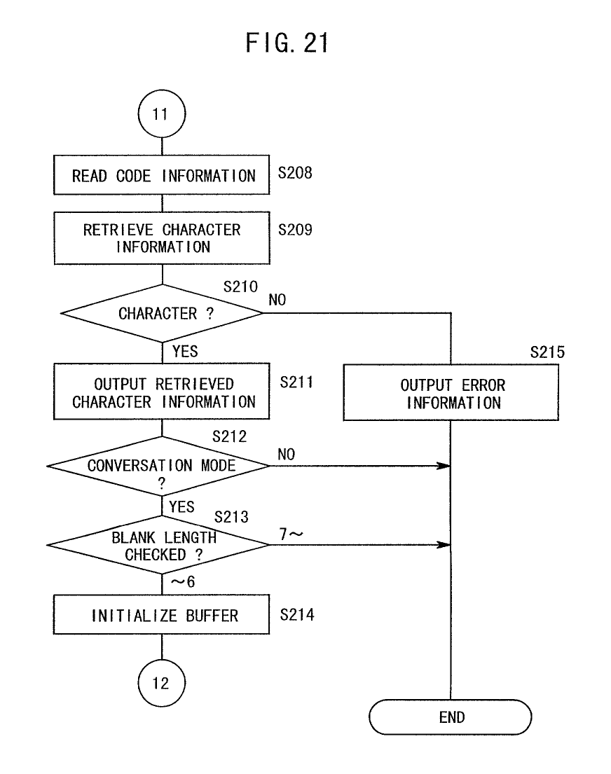

The processing sequence of the character converting means 324 is shown in FIGS. 20 and 21.

In step S201 shown in FIG. 20, the character converting means 324 initializes the buffer 356 (see FIG. 17). In step S202, the sampling means 350 samples the outputting period of a turn-off signal based on one unit of Morse code, and stores the count of the units of the blank length into the second counter 354.

In step S203, the determining means 360 determines whether there is data in the buffer 356 or not. If there is data in the buffer 356, then control goes to step S204 in which the determining means 360 determines whether a character is to be converted or not based on whether or not the count of the units of the blank length stored in the second counter 354 is 3 or more.

If there is no data in the buffer 356 in step 5203 or if the count of the units of the blank length stored In the second counter 354 is 2 or less in step S204, then control goes to step S205 in which the sampling means 350 samples the outputting period of a turn-on signal based on one unit of Morse code, and stores the count of the units of the signal length into the first counter 352.

In step S206, the code information storing means 358 checks if the signal from the input processing means 320 represents dot information or dash information based on the count of the units of the signal length which Is stored In the first counter 352. In step S207, the code information storing means 358 stores the code information based on the checked result into the buffer 356 in successive addresses. For example, if the checked result indicates dot information, then the logic data “10” is stored into the buffer 356, and if the checked result indicates dash information, then the logic data “11” is stored into the buffer 356.

After the processing in step S207, control returns to step S202 to repeat the processing from step S202.

If the count of the units of the blank length stored in the second counter 354 is 3 or more in step S204, then control goes to step S208 show in FIG. 21 in which the character retrieving means 362 reads the code information from the buffer 356. Thereafter, in step S209, the character retrieving means 362 retrieves character information corresponding to the code information stored in the buffer 356 from the information table 330.

In step S210, the character retrieving means 362 determines whether character information corresponding to the code information stored in the buffer 356 is present in the Information table 330 or not. If corresponding character information is present in the information table 330, then control goes to step S211 in which the character retrieving means 362 outputs the retrieved character information.

In step S212, the character converting means 324 determines whether the conversation mode is presently executed or not. In the conversation mode, since a word 220 composed of a plurality of characters, rather than a single character, is processed, successive characters need to be converted.

Therefore, if the conversation mode is presently executed, then control goes to step S213 in which the determining means 360 determines whether a character relative to a next input is to be converted or not based on whether or not the count of the units of the blank length stored in the second counter 354 is 6 or less.

If the count of the units of the blank length stored In the second counter 354 is 6 or less, then control goes to step S214 in which the character converting means 324 initializes the buffer 356. Thereafter, control goes to step S205 shown in FIG. 20.

If the conversation mode Is not presently executed in step S212 or if the count of the units of the blank length stored in the second counter 354 is 7 or more In step S213, then the processing sequence of the character converting means 324 is put to an end.

If corresponding character information is not present In the information table 330 in step S210, then control proceeds to step S215 in which the character retrieving means 362 outputs error Information rather than character information. Thereafter, the processing sequence of the character converting means 324 is ended.

In the main routine shown In FIG. 19, the study mode processing means 302 determines whether there is error information outputted from the character converting means 324 with respect to the character conversion or not in step S112. If there is no error information outputted from the character converting means 324 with respect to the character conversion, then control goes to step S113 In which the determining means 342 determines whether the character information from the character converting means 324 matches character information stored in the reference character memory 336, i.e., character information based on the code entered by the user, or not. If the character information from the character converting means 324 matches character information stored in the reference character memory 336, then control goes to step S114 In which the determined result displaying means 344 displays “◯”, indicative of a match, in the entire displayed view of the display unit 90, as shown in FIG. 9C.

If the character information from the character converting means 324 does not match character information stored in the reference character memory 336, then control goes to step S115 in which the determined result displaying means 344 displays “x”, Indicative of a matching failure, in the entire displayed view of the display unit 90, as shown in FIG. 9B.

If there is error information outputted from the character converting means 324 with respect to the character conversion in step S112, then control goes to step S116 in which the determined result displaying means 344 displays “NG”, indicative of no corresponding character, in the entire displayed view of the display unit 90, as shown in FIG. 9A.

After the processing in either one of steps S114-S116 or if there is no test request from the user In step S109, control goes to step S117 to determine whether there is a program end request for the study mode processing means 302 or not.

If there is no program end request, then control goes back to step S101 to repeat the processing from step S101. If there is a program end request, then the processing sequence of the study mode processing means 302 comes to an end.

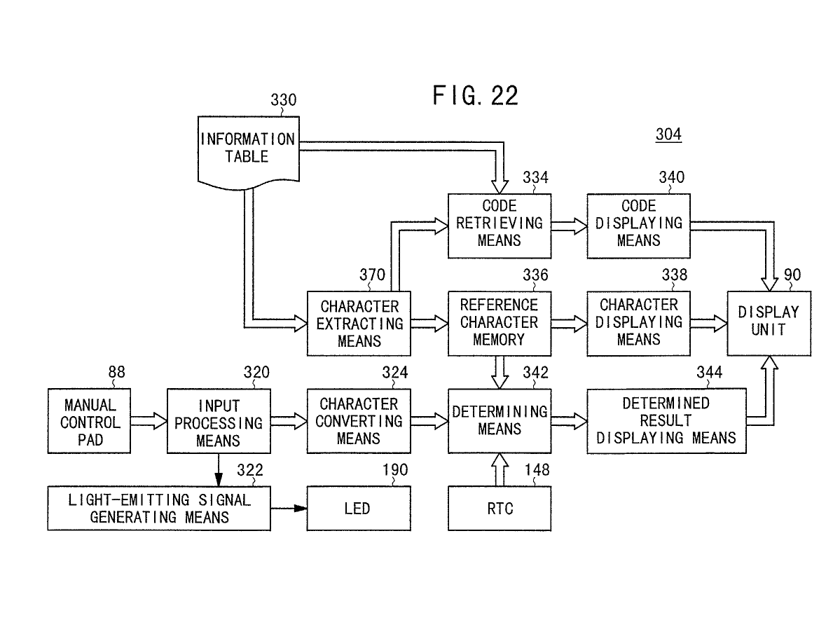

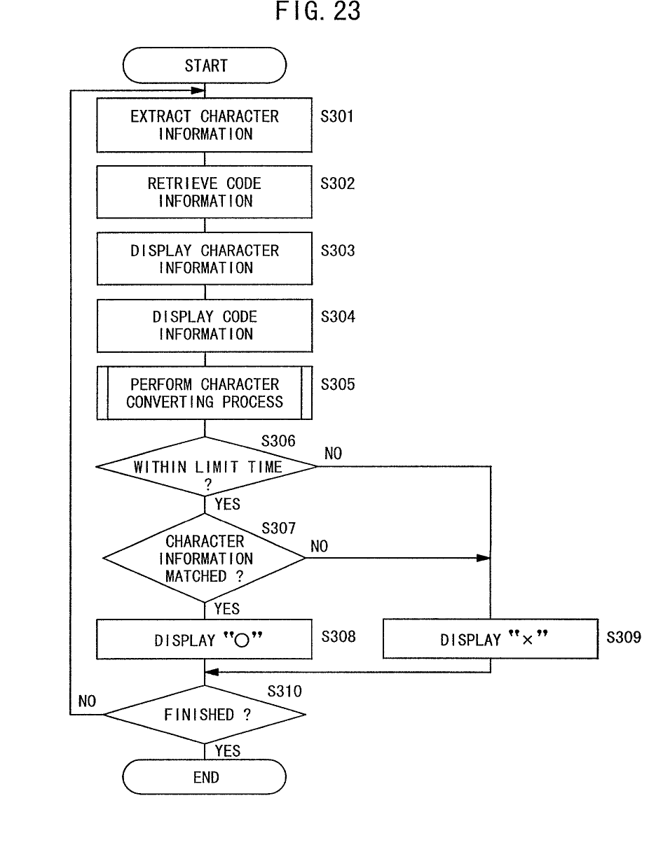

The practice mode processing means 304 will be described below with reference to FIGS. 22 and 23. Those parts of the practice mode processing means 304 which are identical to those shown in FIG. 14 are denoted by identical reference numerals, and will not be described in detail below.

As shown in FIG. 22, the practice mode processing means 304 has the input processing means 320, the character converting means 324, the determining means 342, the determined result displaying means 344, the code retrieving means 334, the code displaying means 340, and the character displaying means 338, and also additionally has a character extracting means 370 for randomly extracting character information from the information table 330 and storing the extracted character information into the reference character memory 336.

The determining means 342 determines whether the character information from the character converting means 324 matches the character information stored in the reference character memory 336 or not, whether error information is outputted from the character converting means 324 or not, and whether the limit time has elapsed or not based on time information from the RTC 148.

The code retrieving means 334 retrieves code information corresponding to the character information extracted by the character extracting means 370 from the information table 330.

A processing sequence of the practice mode processing means 304 will be described below with reference to FIG. 23.

In step S301 shown in FIG. 23, the character extracting means 370 randomly extracts character information from the information table 330, and stores the extracted character information into the reference character memory 336.

In step S302, the code retrieving means 334 retrieves code information corresponding to the retrieved character information from the information table 330. In step S303, the character displaying means 338 displays the character information stored in the reference character memory 336 in the reference display area 208 of the display unit 90, as shown in FIG. 10. In step S304, the code displaying means 340 displays the retrieved code information as a combination of dots and dashes in the reference display area 208 of the display unit 90.

In step S305, the character converting means 324 performs its own processing sequence. Since the processing sequence of the character converting means 324 has already been described above, it will not be described in detail below. At this stage, however, the user enters a code as a combination of dots and dashes, and the input display area 214 of the display unit 90 displays the code entered by the user, with the LED 190 emitting light depending on the entered code.

In step S306, the determining means 342 determines whether the user has entered the code within the limit time or not. If the user has entered the code within the limit time, then control goes to step S307 in which the determining means 342 determines whether the character information from the character converting means 324, i.e., the character information based on the code entered by the user, matches the character information stored In the reference character memory 336 or not. If the character information from the character converting means 324 matches the character information stored in the reference character memory 336, then control goes to step S308 In which the determined result displaying means 344 displays “◯”, indicative of a match, in the entire displayed view of the display unit 90, as shown in FIG. 9C.

If the character information from the character converting means 324 does not match the character information stored in the reference character memory 336 in step S307, if error information is outputted from the character converting means 324, or if the limit time has elapsed in step S306, then control goes to step S309 in which the determined result displaying means 344 displays “x”, indicative of a matching failure, in the entire displayed view of the display unit 90, as shown in FIG. 9B.

After the processing in step S308 or S309, control goes to step S310 to determine whether there is a program end request for the practice mode processing means 304 or not.

If there is no program end request, then control goes back to step S301 to repeat the processing from step S301. If there is a program end request, then the processing sequence of the practice mode processing means 304 is put to an end.

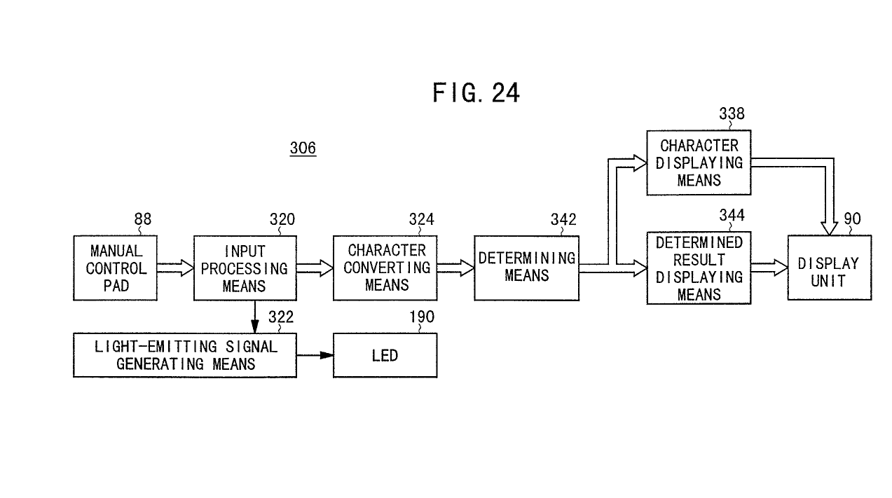

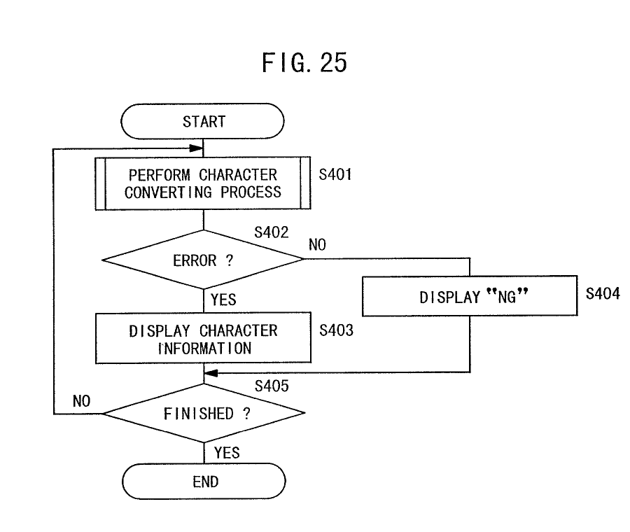

The self-teaching mode processing means 306 will be described below with reference to FIGS. 24 and 25. Those parts of the self-teaching mode processing means 306 which are identical to those shown in FIG. 14 are denoted by identical reference numerals, and will not be described in detail below.

As shown in FIG. 24, the self-teaching mode processing means 306 has the input processing means 320, the character converting means 324, the determining means 342, the character displaying means 338, and the determined result displaying means 344. In the self-teaching mode, the determining 5 means 342 determines whether error information is outputted from the character converting means 324 or not.

In the self-teaching mode processing means 306, the character converting means 324 and the character displaying means 338 jointly serve as a character converting and displaying means.

A processing sequence of the self-teaching mode processing means 306 will be described below with reference to FIG. 25.

In step S401 shown in FIG. 25, the character converting means 324 performs its own processing sequence. Since the processing sequence of the character converting means 324 has already been described above, it will not be described in detail below. At this stage, however, the user enters a code as a combination of dots and dashes, and the Input display area 214 of the display unit 90 displays the code entered by the user, as shown in FIG. 11, with the LED 190 emitting light depending on the entered code.

In step S402, the self-teaching mode processing means 306 determines whether there is error information outputted 25 from the character converting means 324 with respect to the character conversion or not. If there is no error information outputted from the character converting means 324, then control goes to step S403 in which the character displaying means 338 displays character information from the character converting means 324 in the character display area 212 of the display unit 90, as shown in FIG. 11.

If there is error information outputted from the character converting means 324 in step S402, then control goes to step S404 in which the determined result displaying means 344 displays “NG”, indicative of no corresponding character, in the entire displayed view of the display unit 90, as shown In FIG. 9A.

After the processing in step S403 or S404, control goes to step S405 to determine whether there is a program end request for the self-teaching mode processing means 306 or not.

If there is no program end request, then control goes back to step S401 to repeat the processing from step S401. If there is a program end request, then the processing sequence of the self-teaching mode processing means 306 is put to an end.

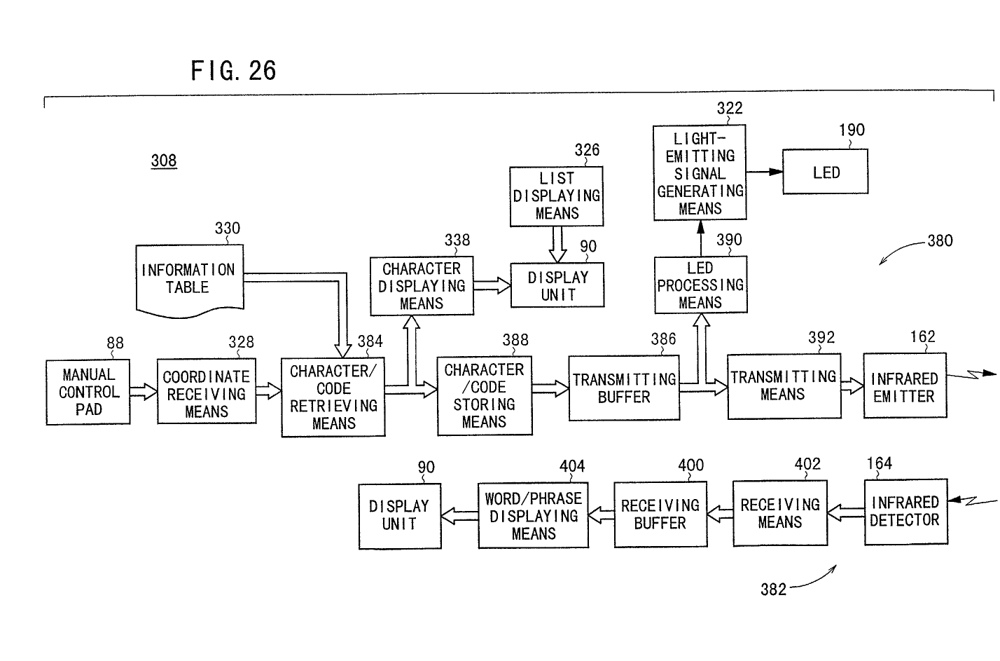

The first conversation mode processing means 308 will be described below with reference to FIGS. 26 through 29. Those parts of the first conversation mode processing means 308 which are identical to those shown in FIG. 14 are denoted by identical reference numerals, and will not be described in detail below.

As shown In FIG. 26, the first conversation mode processing means 308 comprises a transmitter 380 and a receiver 382.

The transmitter 380 has the list displaying means 326, the coordinate receiving means 328, and the character displaying means 38.

The transmitter 380 also comprises a character/code retrieving means 384 for retrieving character information and code information corresponding thereto from the information table 330 based on received coordinates, a character/code storing means 388 for successively storing the character information and the code information from the character/code retrieving means 384 into a transmitting buffer 386, an LED processing means 390 for giving an instruction to the light-emitting signal generating means 322 to enable the LED 190 to emit light depending on a combination of dots and dashes corresponding to a plurality of items of code information among the character information and the code information stored in the transmitting buffer 386, and a transmitting means 392 for reading word/phrase information composed of a plurality of items of character information among the character information and the code information stored in the transmitting buffer 386, and transmitting the read word/phrase information via the infrared emitter 162 to an external device.

The receiver 382 comprises a receiving means 402 for storing word/phrase information received via the infrared detector 164 into a receiving buffer 400, and a word/phrase displaying means 404 for reading word/phrase information stored in the receiving buffer 400 and displaying the read word/phrase Information on the display unit 90.

A processing sequence of the transmitter 380 of the first conversation mode processing means 308 will be described below with reference to FIGS. 26, 27 and 28.

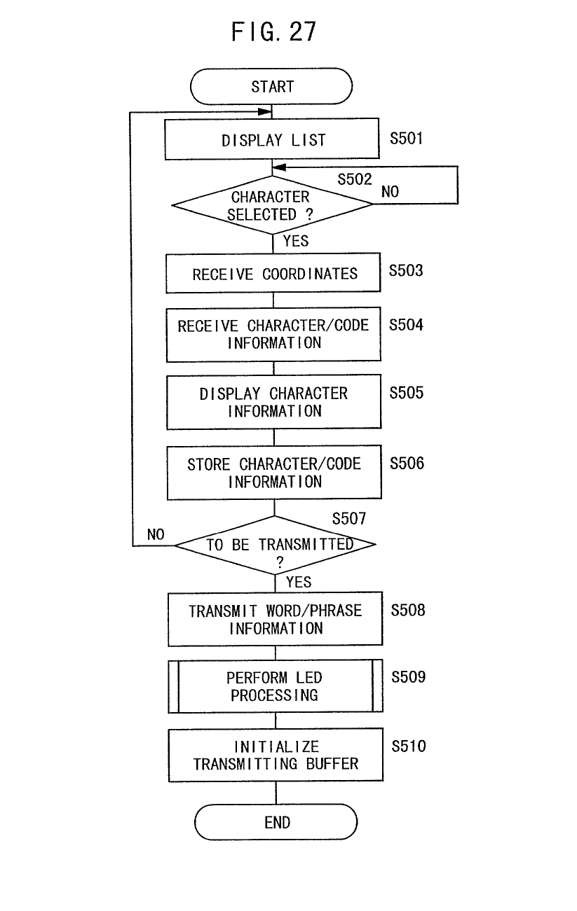

In step S501 shown in FIG. 27, the list displaying means 326 displays the character list 204 on the display unit 90, as shown In FIG. 8B.

In step S502, the transmitter 380 determines whether a character is selected or not based on whether there is an input from the decision button 86 or not. If there is an input from the decision button 86, then control goes to step S503 in which the coordinate receiving means 328 receives positional information (coordinates) of the cursor 206 at the time the decision button 86 is operated.

In step S504, the character/code retrieving means 384 retrieves character information and code information corresponding thereto from the information table 330 based on the received coordinates. In step S505, the character displaying means 338 displays the retrieved character information on the display unit 90.

In step S506, the character/code storing means 388 successively stores the retrieved character information and the code information corresponding thereto into the transmitting buffer 386.

In step S507, the transmitter 380 determines whether there is a transmitting instruction or not. If there is no transmitting instruction, then control goes back to step S501 to process next inputted character information. If there is a transmitting instruction, then control goes to step S508 in which the transmitting means 392 transmits a plurality of items of character information (word/phrase information) stored in the transmitting buffer 386 to external devices via the infrared emitter 162. The transmitted word/phrase information is received by the receiver 382 of another portable information terminal 18.

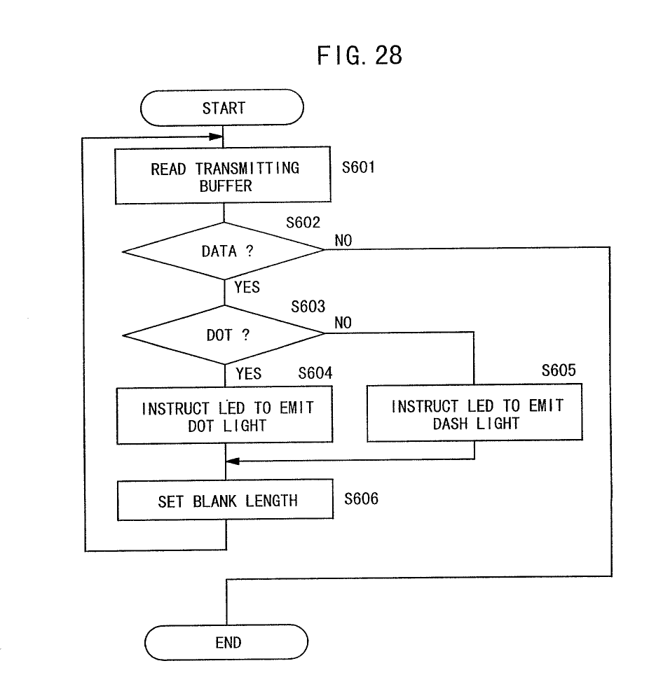

Thereafter, in step S509, the LED processing means 390 performs its own processing sequence. The processing sequence of the LED processing means 390 is illustrated in FIG. 28. In step S601 shown in FIG. 28, the LED processing means 390 successively reads a plurality of items of code information from the items of character and code information stored in the transmitting buffer 386. The read items of code information are successively deleted from the transmitting buffer 386.

In step S602, the LED processing means 390 determines whether there is data (code information) to be read or not. If there is code Information, then control goes to step S603 in which the LED processing means 390 determines whether the read code information is relative to a dot or not based on whether the read logic data is “10” or not.

If the read code information is relative to a dot, then control goes to step S604 in which the LED processing means 390 gives an instruction (dot emitting instruction) to the light-emitting signal generating means 322 to emit a dot of light. In response to the dot emitting instruction from the LED processing means 390, the light-emitting signal generating means 322 causes the LED 190 to emit light for a period corresponding to one unit (dot light emission), for example.

If the read code information is relative to a dash in step S603, then control goes to step S605 In which the LED processing means 390 gives an instruction (dash emitting instruction) to the light-emitting signal generating means 322 to emit a dash of light. In response to the dash emitting instruction from the LED processing means 390, the light-emitting signal generating means 322 causes the LED 190 to emit light for a period corresponding to three units (dash light emission), for example.

After the processing in step S604 or S605, control goes to step S606 in which the LED processing means 390 sets a blank length corresponding to two units between codes that make up one character, and sets a blank length corresponding to seven units between a plurality of characters. In this manner, a blank of two units in which the LED 190 is turned off is placed between codes that make up one character, and a blank length corresponding to seven units is placed between a plurality of characters.

Thereafter, control returns to step S601 to repeat the processing from the step S601. If there is no code information to be read in step S602, the processing sequence of the LED processing means 390 is ended.

Control goes back to the routine shown in FIG. 27. In step S510, the transmitting buffer 386 is initialized, and the processing sequence of the transmitter 380 is put to an end.

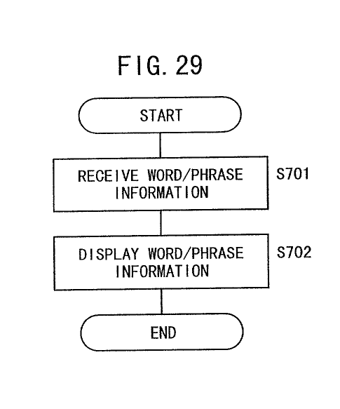

A processing sequence of the receiver 382 of the first conversation mode processing means 308 will be described below with reference to FIG. 29.

In step S701 shown in FIG. 29, the receiving means 402 stores word/phrase information received via the infrared detector 164 into the receiving buffer 400.

In step S702, as shown in FIG. 12. the word/phrase displaying means 404 displays the word/phrase information stored in the receiving buffer 400 on the display unit 90. After the processing in step S702, the processing sequence of the receiver 382 comes to an end.

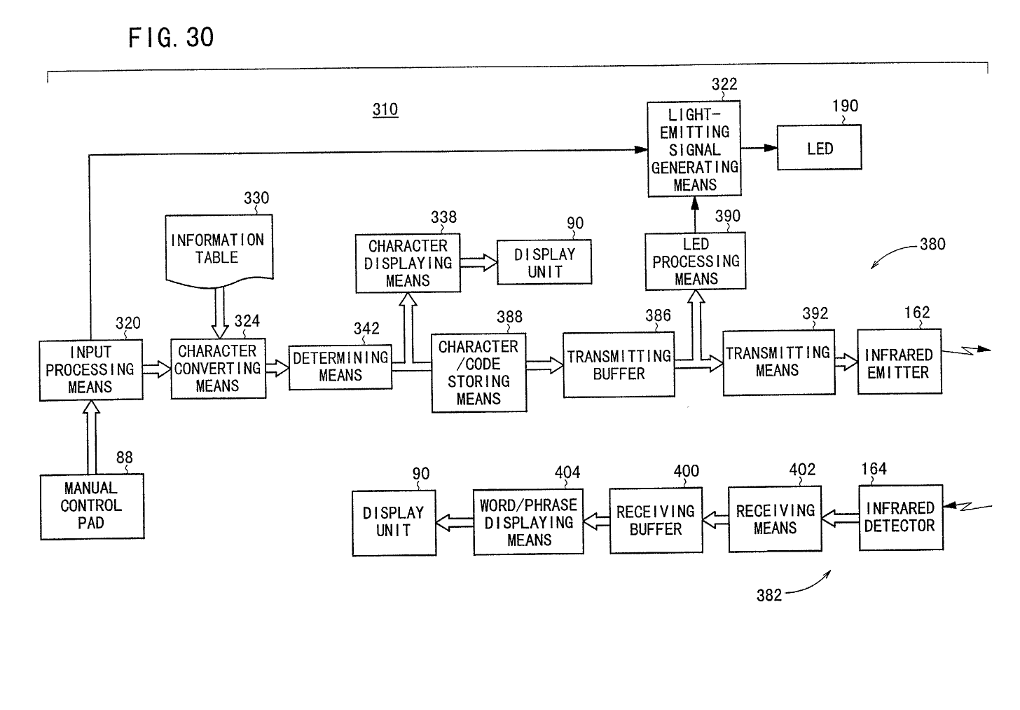

The second conversation mode processing means 310 will be described below with reference to FIG. 30. As shown in FIG. 30, the second conversation mode processing means 310 comprises a transmitter 380 and a receiver 382. The transmitter 380 of the second conversation mode processing means 310 has the input processing means 320, the character converting means 324, the determining means 342, the character displaying means 338, the character/code storing means 388, the transmitting means 392, and the LED processing means 390. At the time the determining means 342 determines that there is character information, the character displaying means 338 displays the character information on the display unit 90.

The receiver 382 of the second conversation mode processing means 310 is identical to the receiver 382 of the first conversation mode processing means 308, and will not be described below.

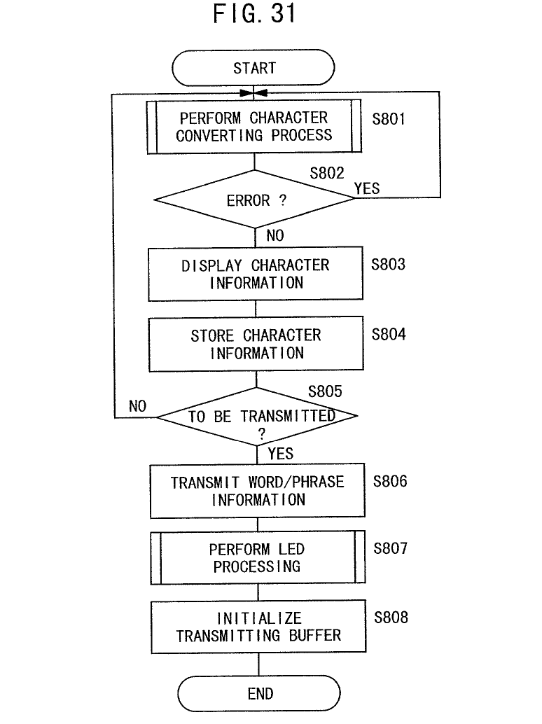

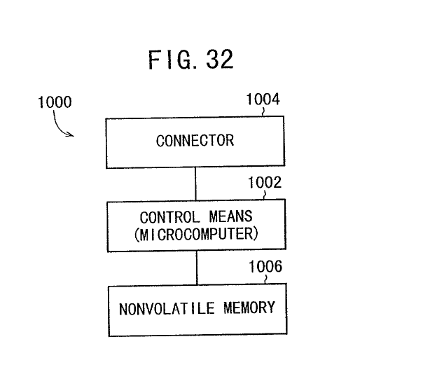

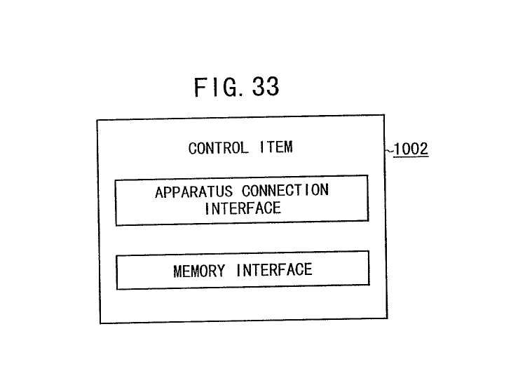

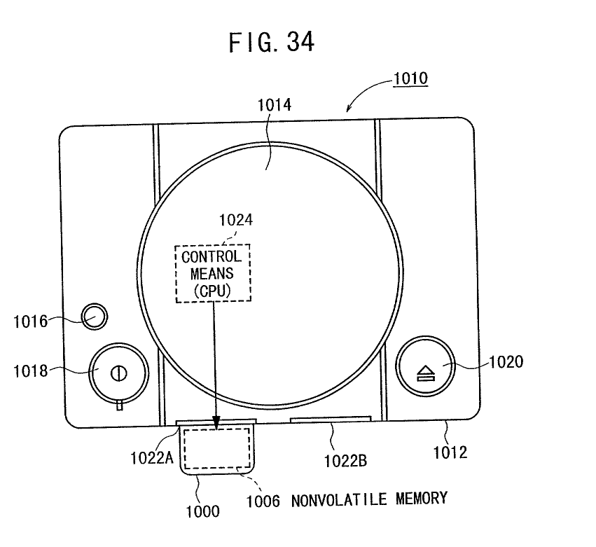

A processing sequence of the second conversation mode processing means 310 will be described below with reference to FIG. 31.

In step S801 shown in FIG. 31, the character converting means 324 performs its own processing sequence. Since the processing sequence of the character converting means 324 has already been described above, it will not be described in detail below. At this stage, however, the user enters a code as a combination of dots and dashes, and the display unit 90 displays the code entered by the user, with the LED 190 emitting light depending on the entered code.

In step S802, the transmitter 380 determines whether there is error Information outputted from the character converting means 324 with respect to the character conversion or not. If there is error information outputted from the character converting means 324, the character converting means 324 performs its own processing sequence in step S801. At this time, the display unit 90 may display “NG”. If there is no error information, then control goes to step S803 In which the character displaying means 338 displays character information from the character converting means 324 on the display unit 90.

In step S804, the character/code storing means 388 stores the character information and the code information which have been retrieved in the transmitting buffer 386.

In step S805, the transmitter 380 determines whether there is a transmitting instruction or not. If there is no transmitting instruction, then control goes back to step S801 to process next inputted character information. If there is a transmitting instruction, then control goes to step S806 in which the transmitting means 392 transmits a plurality of items of character information (word/phrase information) stored in the transmitting buffer 386 via the infrared emitter 162. The transmitted word/phrase information is received by the receiver 382 of another portable information terminal 18.

In step S807, the LED processing means 390 performs its own processing sequence. The processing sequence of the LED processing means 390 has already been described above, and will not be described in detail below. In the processing sequence of the LED processing means 390, the LED 190 emits light representing a Morse code corresponding to the character information to be transmitted.

In step S808, the transmitting buffer 386 is initialized. The processing sequence of the transmitter 380 of the second conversation mode processing means 310 is now ended.

The processing sequence of the receiver 382 of the second conversation mode processing means 310 is identical to the processing sequence of the receiver 382 of the first conversation mode processing means 308, and will not be described below.

As described above, the portable information terminal 18 according to the present invention converts a Morse code entered via the manual control pad 88 into character information and displays the character information on the display unit 90 Therefore, the portable information terminal 18 allows the user to generate characters with Morse codes. The portable information terminal 18 can be used as a portable game machine, and can generate character information with Morse codes and communicate with another portable information terminal 18 with the generated character information.

Since the LED 190 is turned on in synchronism with the inputting of a Morse code, the LED 190 emits light depending on the inputting of the Morse code. Therefore, the user can recognize the relationship between a Morse code and a character based on a visual sensation such as of light emission as well as the inputting of the Morse code. The emission of light from the LED 190 is effective to assist the user in memorizing Morse codes, for example.

Inasmuch as character information entered via the manual control pad 88 is converted into a Morse code, the portable information terminal 18 is suitable for use in communications with external devices using Morse codes. Furthermore, because the LED 190 emits lights depending on a converted Morse code, the portable information terminal 18 makes it possible to perform optical communications using Morse codes.

The portable information terminal 18 has the transmitter 380 for transmitting character information via the infrared emitter 162 and the receiver 382 for receiving character information via the infrared detector 164 and for displaying the character information on the display unit 90. Thus, the portable information terminal 18 is capable of performing sending and receiving character information through both optical communications using Morse codes and wireless communications in a radio frequency range (RF range) and an infrared range (IR range ). The user finds it interesting to use the portable information terminal 18 because it can simulate communications using Morse codes.

Although a certain preferred embodiment of the present invention has been shown and described in detail, it should be understood that various changes and modifications may be made therein without departing from the scope of the appended claims.

What is claimed is:

1. A portable information terminal comprising:
a housing having input means for entering an input, control means for executing a program; and display means for displaying a generated image: and
character converting and displaying means operable on said control means for converting an unequal-length code inputted via said input means into character information and displaying the character information on said display means

2. A portable information terminal according to claim 1, wherein said housing has light-emitting means for emitting light in response to a light-emitting signal, further comprising:
light-emitting signal generating means operable on said control means for generating a light-emitting signal in synchronism with the inputting of said unequal-length code and outputting the generated light-emitting signal to said light-emitting means.

3. A portable information terminal according to claim 1, further comprising:
code converting means operable on said control means for converting character information inputted via said input means into an unequal-length code.

4. A portable information terminal according to claim 3, wherein said housing has light-emitting means for emitting light in response to a light-emitting signal, further comprising:
light-emitting signal generating means operable on said control means for generating a light-emitting signal based on the converted unequal-length code and outputting the generated light-emitting signal to said light-emitting means.

5. A portable information terminal according to claim 1, wherein said housing has communication means for exchanging information with an external device, further comprising:
information transmitting means operable on said control means for transmitting said character information via said communication means to the external device.

6. A portable information terminal according to claim 1, wherein said housing has communication means for exchanging information with an external device, further comprising:
information receiving means operable on said control means for receiving said character information via said communication means from the external device, and displaying the received character information on said display means.

7. A recording medium storing a program and data for use in a portable information terminal having input means for entering an input, control means for executing a program, and display means for displaying a generated image, said program being operable on said control means and comprising the steps of:
converting an unequal-length code inputted via said input means into character information, and displaying the character information on said display means.

8. A recording medium according to claim 7, wherein said portable information terminal has light-emitting means for emitting light in response to a light-emitting signal, said program further comprising the steps of:
generating a light-emitting signal in synchronism with the inputting of said unequal-length code and outputting the generated light-emitting signal to said light-emitting means.

9. A recording medium according to claim 7, further comprising the step of:
converting character information inputted via said input means into an unequal-length code.

10. A recording medium according to claim 9, wherein said portable information terminal has light-emitting means for emitting light in response to a light-emitting signal, said program further comprising the steps of:
generating a light-emitting signal based on the converted unequal-length code and outputting the generated light-emitting signal to said light-emitting means.

11. A recording medium according to claim 7, wherein said portable information terminal has communication means for exchanging information with an external device, said program further comprising the step of:
transmitting said character information via said communication means to the external device.

12. A recording medium according to claim 7, wherein said portable information terminal has communication means for exchanging information with an external device, said program further comprising the steps of:
receiving said character information via said communication means from the external device, and displaying the received character information on said display means.

13. A program readable and executable by a computer, for use in a portable information terminal having input means for entering an input, control means for executing a program, and display means for displaying a generated image, said program being operable on said control means and comprising the steps of:
converting an unequal-length code inputted via said input means into character information, and displaying the character information on said display means.
